(19) United States
(12) Patent Application Publication
(10) Pub. No.: US 2009/0148364 A1
(43) Pub. Date: Jun. 11, 2009

(54) Method for Increasing the Yield When Chlorinating Titaniferous Raw Materials

(76) Inventors: Heiko Frahm, Leverkusen (DE); Joerg Friedrich, Leverkusen (DE); Dirk Floeder, Essen (DE)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 12/269,993

(22) Filed: Nov. 13, 2008

Related U.S. Application Data
(60) Provisional application No. 61/037,474, filed on Mar. 18, 2008.

(30) Foreign Application Priority Data
Dec. 5, 2007 (DE) DE 102007058900.1
Mar. 18, 2008 (DE) DE 102008014722.2

(51) Int. Cl. C01G 23/02

(52) U.S. Cl. 423/74

(57) ABSTRACT

A method for reprocessing cyclone dust occurring during the carbochlorination of titaniferous raw materials, which essentially consists of titanium dioxide, coke and other inert metal oxides, such as silicon dioxide, and for returning a coke-rich and/or a TiO₂-rich fraction to the chlorination reactor includes:
preparing an aqueous suspension of the cyclone dust;
separating a coke-rich fraction (1) from the aqueous suspension by flotation;
adding hydrofluoric acid to the remaining suspension; and
separating a TiO₂-rich fraction (2) by flotation from the remaining suspension.

### RELATED APPLICATIONS

This application claims the benefit of U.S. Provisional Patent Application Ser. No. 61/037,474 filed Mar. 18, 2008, and entitled “Process for Increased Yield When Chlorinating Titanferous Materials” and the benefit of DE 102007058900.1 filed Dec. 5, 2007 and DE 102008014722.2 filed Mar. 18, 2008.

### TECHNICAL FIELD OF THE INVENTION

The invention relates to a method for reprocessing the cyclone dust occurring during the carbochlorination of titaniferous raw materials, which essentially consists of titanium dioxide, coke and other inert metal oxides, such as silicon dioxide, and for returning a coke-rich and/or a TiO₂-rich fraction to the chlorination reactor.

### BACKGROUND OF THE INVENTION

Volatile metal chlorides are formed during the process for producing titanium tetrachloride by chlorination of titaniferous raw materials in the presence of coke in a fluidized-bed reactor at temperatures in the region of 1,000° C. When the metal chlorides are discharged from the reactor, fine bed material, especially unreacted titaniferous raw material (TiO₂), further inert metal oxides from the raw material (particularly SiO₂, essentially in the form of quartz) and coke are also entrained. This gas-solid mixture is cooled to approx. 150° C. The solid component is separated out in a cyclone. The mixture of solids obtained in this way is referred to as cyclone dust below. It is customary practice for the iron chloride component to subsequently be washed out of the cyclone dust.

The washed cyclone dust contains about 20% to 40% by weight TiO₂, 30% to 50% by weight coke and 10% to 20% by weight SiO₂. The cyclone dust cannot be returned to the reactor in this form because this would consequently lead to accumulation of quartz in the fluidized bed of the chlorination reactor and thus to premature slagging.

A method for reprocessing the cyclone dust and subsequently returning part of it to the reactor is described in EP 0 714 992 B1. In this method, the cyclone dust is separated into a TiO₂-enriched fraction and a coke-enriched fraction with the help of a hydrocyclone. After further milling, the TiO₂-enriched fraction, which still contains about 9% by weight quartz, can be returned to the reactor, while the coke-rich fraction is suitable as fuel, e.g. for cement works or coal-fired power stations. Milling of the TiO₂-enriched fraction to a particle size of about <0.1 mm is necessary in order to convert the returned TiO₂ particles into TiCl₄ sufficiently quickly and to ensure that the majority of the returned quartz particles do not remain in the fluidized bed, but are swiftly discharged again with the gas stream. However, this method leads to accumulation of quartz in the cyclone dust and more severe slagging, and permits only partial utilisation of the TiO₂ and coke components of the cyclone dust.

### SUMMARY OF THE INVENTION

The present method provides for separating out and reprocessing the TiO₂ and coke components of the cyclone dust occurring during the carbochlorination of titaniferous raw materials, which essentially consists of titanium dioxide, coke and further inert metal oxides. The method includes:
preparing an aqueous suspension of the cyclone dust;
separating a coke-rich fraction (1) from the aqueous suspension by flotation;
adding hydrohalic acid to the remaining suspension; and
separating a TiO₂-rich fraction (2) by flotation from the remaining suspension.

### DESCRIPTION OF THE PREFERRED EMBODIMENTS

The method according to the present invention permits extensive separation of the cyclone dust into three solid fractions: titanium dioxide, coke and inerts. When used below, the term “inerts” is to be taken as meaning all other metal oxides contained in the cyclone dust alongside SiO₂, with the exception of TiO₂.

The method according to the present invention is based on a solid (cyclone dust) that, during titanium dioxide production by the chloride process, is discharged from the chlorination reactor in a gas-solid mixture, cooled—e.g. by injection of cool titanium tetrachloride—and separated out in a cyclone. The iron chloride component of the cyclone dust is optionally washed out in a further step.

The cyclone dust is subsequently repulped with water to form a first suspension in a Step a).

In a subsequent Step b), the coke is separated from the cyclone dust suspension as a fraction (1) by flotation. A suitable flotation agent is added to the cyclone dust suspension to this end. Although the person skilled in the art is familiar with the customary methods for coal flotation, these methods cannot be applied without further ado to the flotation of coke, which is highly porous by comparison.

Fundamentally suitable in the context of the invention are flotation agents based on aromatic and/or aliphatic hydrocarbons (e.g. middle distillates from crude-oil distillation, such as diesel oil, etc.), as known from DE 103 20 191 A1, for example. Particularly suitable is EKOFOL 440®. EKOFOL 440® is a combination collecting/foaming agent, manufactured by EKOF Flotation GmbH and containing aliphatic alcohols in the C6 to C10 range, esters, ethers, hydrocarbons and surfactants.

The flotation agent is added in quantities of about 10 g/t to 5,000 g/t cyclone dust, preferably about 100 g/t to 1,500 g/t cyclone dust. The method can be performed using all known flotation systems, preferably with a pneumatic flotation cell (e.g. PNEUFLOT® from Humboldt-Wedag). Flotation is preferably performed without a conditioning period, particularly with the flotation agent EKOFOL 440®.

The solid component of the remaining suspension contains about 60% to 99% by weight TiO₂, about 1% to 40% by weight inerts and a maximum of about 2% to 5% by weight coke residues.

In a subsequent Step c), a hydrohalic acid, preferably hydrofluoric acid, is added to the remaining suspension. The acid is preferably added in a quantity of about 0.05 kg/t to about 50 kg/t solids, particularly in a quantity of about 1 kg/t to about 10 kg/t solids. Hydrofluoric acid is frequently used to modify silicate flotation because the fluoride influences the surface properties of silicates and thus acts either as a activating reagent or as a passivating reagent (“depressant”), depending on the prevailing conditions.

In a subsequent Step d), titanium dioxide is separated out as fraction (2) by flotation. A suitable flotation agent is added to this end. Suitable flotation agents are nitrogen or phosphorus-containing reagents, preferably amines or phosphonates, particularly RESANOL BA®. RESANOL BA® is a combination collecting/foaming agent manufactured by EKOF Flotation GmbH. The flotation agent is preferably added in a quantity of about 100 g/t to about 2,000 g/t solids, particularly about 100 g/t to about 1,000 g/t solids.

The hydrohalic acid added leads to extensive passivation of the surface of the SiO₂ particles, meaning that the flotation agent is predominantly not adsorbed on the SiO₂ particles. Accordingly, SiO₂ predominantly remains in the suspension as a residue.

The flotation products, coke fraction (fraction (1)) and TiO₂ fraction (fraction (2)), occur in the form of aqueous suspensions, which can be dewatered and, where appropriate, dried in a subsequent Step e). Dewatering and drying can be performed by standard methods familiar to the person skilled in the art.

An embodiment of the present invention, the method is implemented as follows: Iron chloride-containing cyclone dust is used and, in Step a), repulped into a chlorohydric first suspension, using chlorohydric water where appropriate. Following coke separation in accordance with Step b), the remaining first suspension is dewatered to obtain a filter cake. Dewatering can be performed by standard methods familiar to the person skilled in the art, e.g. using filter presses.

The filter cake obtained, which consists of about 60% to 99% by weight TiO₂ and about 40% to 1% by weight inerts and residual coke not completely separated out in Step b) (max. about 2% to 5% by weight), is subsequently repulped into a second suspension with water. The second suspension has a solids content of about 1% to 40% by weight.

Subsequently, hydrofluoric acid is first added to the second suspension in Step c), as before, and titanium dioxide is separated out as fraction (2) by means of flotation in Step d). In Step e), the flotation products, coke fraction (fraction (1)) and TiO₂ fraction (fraction (2)), obtained in the form of aqueous suspensions, are, as before, dewatered and, where appropriate, dried.

The dewatered and, where appropriate, dried coke fraction (fraction (1)) can be used as raw material for carbochlorination, or as a fuel, e.g. in the cement industry or for coal-fired power stations.

The dewatered and, where appropriate, dried TiO₂ fraction (fraction (2)) can be returned to the chlorination reactor as raw material, or used as raw material in the production of titanium dioxide by the sulphate process.

The TiO₂ fraction (fraction (2)) is preferably agglomerated so that it can be conveyed into the reactor in the conventional manner, together with the raw materials for the chlorination of titaniferous raw materials (ore, coke), and so that it can remain sufficiently long in the bubbling, fluctuating fluidized bed in the chlorination reactor and be converted into TiCl₄. To this end, the moist filter cake (fraction (2)) is preferably mixed with suitable binders and subsequently agglomerated. The green bodies formed during agglomeration are optionally dried and subsequently subjected to thermal treatment at temperatures of at least about 800° C., or alternatively at temperatures of at least about 1,250° C.

Water, polymer solutions like polyethylene oxide, methyl cellulose, starch, sugar derivatives, etc., or surfactant or salt solutions, can be used as binders. Alkali chlorides, such as sodium chloride, are particularly suitable as binders.

The use of sodium chloride (melting point 801° C.) in quantities in the region of about 1% by weight to 99% by weight can lower the temperature required for thermal treatment, since its melting point is below the sintering temperature of titanium dioxide (approx. 1,250° C.). The molten salt “cements” the TiO₂ particles, meaning that dimensionally stable and conveyable TiO₂ agglomerates result after cooling. A further advantage of sodium chloride as the binder is that it has to be added to the chlorination process anyway and thus does not constitute a contaminant for the process. In a preferred embodiment of the method, about 10% to about 30% by weight NaCl are used as binder, referred to dry TiO₂.

The use of binders other than NaCl, particularly the use of organic binders, can result in decomposition of the binders during thermal treatment, there thus being no consolidation of the thermally treated green bodies. Consequently, to obtain dimensionally stable and conveyable TiO₂ agglomerates in such a case, a higher temperature than when using sodium chloride is needed for thermal treatment, lying at least in the region of the sintering temperature of TiO₂.

In another embodiment of the present invention agglomeration of the TiO₂ fraction (fraction (2)) may be performed by adding other fine grained carrier materials like e.g. Ti-containing slag, coke or TiO₂. Basically, all fine grained materials which do not disturb the chlorination process are suitable.

Pelletizing discs, pelletising drums, mixing agglomerators, e.g. ploughshare mixers, Eirich mixers, Cyclomix units or other apparatus familiar to the person skilled in the art can be used as agglomeration equipment.

Thermal treatment of the green bodies can be performed in standard kilns, such as muffle kilns or rotary kilns. The moisture content of the TiO₂ green bodies is preferably about 5% to 25% by weight. Thermal treatment should preferably last for over 1 hour and up to 8 hours.

The dried agglomerates are conveyed into the reactor together with the other raw materials for carbochlorination. Owing to the size of the agglomerates obtained, which is preferably about 0.2 mm to 1.5 mm, the agglomerates can be conveyed into the reactor together with other titaniferous raw materials without problems occurring in the conveyor system as a result of fine material. In a preferred embodiment, the salt content added to the reactor in the form of TiO₂ agglomerates is less than about 12 kg per tonne of the total quantity of TiO₂ agglomerates plus ore.

In another embodiment of the invention, the TiO₂ fraction of the cyclone dust (fraction (2)) is returned to the reactor in non-agglomerated form as dry powder.

The method according to the invention makes it possible to reduce the specific raw material requirement when producing titanium tetrachloride by carbochlorination of titaniferous raw materials, or the method minimises the losses of coke and titanium dioxide without inducing premature slagging of the reactor.

### EXAMPLES

The invention is explained in more detail on the basis of the examples below, although this is in no way intended to restrict the invention.

### Example 1

Cyclone dust obtained from carbochlorination was repulped into a 5% by weight suspension with chlorohydric water.

To separate out the coke, 300 g/t solids EKOFOL 440® was added to this chlorohydric, iron chloride-containing suspension. Flotation was performed using a PNEUFLOT® (Humboldt-Wedag). A coke-rich suspension in chlorohydric, iron chloride-containing water was obtained after a flotation time of about 4 minutes (fraction (1)).

The purity of the coke fraction was >90% by weight, the yield being >90% by weight.

The suspension of TiO₂ and inert metal oxides remaining after coke flotation was dewatered with a chamber filter press. The composition of the filter cake was about 70% by weight TiO₂, about 10% by weight inert metal oxides, small amounts of coke and about 20% by weight water.

The filter cake was subsequently repulped with water to produce a suspension with a solids content of 100 g/l. 10 kg HF per tonne solids were added to the suspension. The pH value of the suspension was about 2. 500 g/t solids RESANOL BA® was subsequently added. Flotation of the TiO₂ was performed using a PNEUFLOT® (Humboldt-Wedag). A TiO₂-rich suspension in water was obtained after a flotation time of about 8 minutes (fraction (2)). The purity of the TiO₂ fraction was >90% by weight, the TiO₂ yield being >70% by weight. The suspension of the TiO₂ fraction was dewatered with a chamber filter press.

The moist filter cake of the TiO₂ fraction (15% by weight moisture) was mixed with 15% by weight NaCl, agglomerated in a pelletising drum and subsequently treated thermally in a muffle kiln for 8 hours at 850° C.

### Example 2

Cyclone dust obtained from carbochlorination was repulped into a 10% by weight suspension with chlorohydric water, and 700 g/t solids EKOFOL 440® was subsequently added for coke flotation.

The subsequent procedure was as described for Example 1, and the same results were obtained.

### Example 3

Cyclone dust obtained from carbochlorination was repulped into a 20% by weight suspension with chlorohydric water, and 300 g/t solids EKOFOL 440® was subsequently added for coke flotation.

The subsequent procedure was as described for Example 1, and the same results were obtained.

### Example 4

Cyclone dust obtained from carbochlorination was repulped into a 20% by weight suspension with chlorohydric water. The solids were isolated from this suspension by filtration in a chamber filter press. The composition of the solids was about 35% by weight coke, 30% by weight titanium dioxide, 25% by weight water and 10% by weight inert metal oxides.

These solids were repulped with water to produce a suspension with a solids content of 100 g/l, and 300 g/t solids EKOFOL 440® was added to separate out the coke. Flotation was performed in a PNEUFLOT® (Humboldt-Wedag). A coke-rich suspension in water was obtained after a flotation time of about 4 minutes (fraction (1)). The purity of the coke fraction was >90% by weight, the yield being >90% by weight.

5 kg HF per tonne solids was added to the suspension of TiO₂ and inert metal oxides remaining after coke filtration. The pH value of the suspension was about 2. 500 g/t solids RESANOL BA® was subsequently added. Flotation of the TiO₂ was performed using a PNEUFLOT® (Humboldt-Wedag). A TiO₂-rich suspension in water was obtained after a flotation time of about 8 minutes (fraction (2)). The purity of the TiO₂ fraction was >90% by weight, the TiO₂ yield being >70% by weight. The suspension of the TiO₂ fraction was dewatered with a chamber filter press.

The moist filter cake of the TiO₂ fraction (15% by weight moisture) was mixed with 15% by weight NaCl, agglomerated in a pelletising drum and subsequently treated thermally in a muffle kiln for 8 hours at 850° C.

### Example 5

The procedure was the same as in Example 4, except that the solids (cyclone dust) isolated with the filter press were repulped into a suspension with a solids content of 300 g/l instead of a solids content of 100 g/l. The same results were obtained as in Example 4.

1. A method for reprocessing cyclone dust occurring during the carbochlorination of titaniferous raw materials in a reactor, which essentially consists of titanium dioxide, coke and further inert metal oxides, the method comprising:
a) preparing a first, aqueous suspension of the cyclone dust;
b) separating a coke-rich fraction from the aqueous suspension by flotation;
c) adding hydrohalic acid to the remaining suspension; and
d) separating a TiO₂-rich fraction by flotation from the remaining suspension.

2. The method of claim 1 whereby flotation is performed without a conditioning period in Step b).

3. The method of claim 1 and further including:
adding hydrofluoric acid in Step c).

4. The method of claim 3 wherein the hydrofluoric acid is added in a quantity of about 0.05 kg to about 50 kg HF/t solids in Step c).

5. The method of claim 1 and further including:
adding a flotation agent selected from the group consisting of nitrogen and phosphorus-containing reagents in Step d).

6. The method of claim 5 wherein the phosphorus-containing reagents are selected from the group consisting of amines and phosphonates.

7. The method of claim 5 wherein the flotation agent is added in a quantity of about 100 to about 2,000 g/t solids.

8. The method of claim 1 and further including: mixing the TiO₂-rich fraction with a binder, subsequently agglomerating and thermally treating the mixture at a temperature of at least about 800° C. and returning the mixture to the reactor.

9. The method of claim 8 wherein the binder is selected from the group consisting of: polymer solutions, surfactant solutions, salt solutions, and NaCl.

10. The method of claim 8 wherein the binder is about 10% to 30% by weight NaCl, referred to dry TiO₂.

11. The method of claim 1 and further including: mixing the TiO₂-rich fraction with a fine grained carrier material, subsequently agglomerating and thermally treating the mixture at a temperature of at least about 800° C. and returning the mixture to the reactor.

12. The method of claim 11 wherein the fine grained carrier material is selected from the group consisting of: TiO₂, Ti-containing slag and coke.

13. A method for reprocessing cyclone dust occurring during the carbochlorination of titaniferous raw materials in a reactor, which essentially consists of titanium dioxide, coke and further inert metal oxides, the method comprising:
a) preparing a first, chlorohydric aqueous suspension of the cyclone dust;
b) separating a coke-rich fraction from the chlorohydric aqueous suspension by flotation;
c) dewatering the remaining suspension to obtain a filter cake;
d) repulping the filter cake with water to obtain a second suspension;
e) adding hydrohalic acid to the second suspension; and
f) separating a TiO₂-rich fraction by flotation from the second suspension.

14. The method of claim 13 whereby flotation is performed without a conditioning period in Step b).

15. The method of claim 13 and further including:
adding hyrdrofluoric acid in Step e).

16. The method of claim 15 wherein the hydrofluoric acid is added in a quantity of about 0.05 kg to about 50 kg HF/t solids in Step e).

17. The method of claim 13 and further including:
adding a flotation agent selected from the group consisting of nitrogen and phosphorus-containing reagents, in Step f).

18. The method of claim 17 wherein the phosphorus-containing reagents are selected from the group consisting of amines and phosphonates.

19. The method of claim 17 wherein the flotation agent is added in a quantity of about 100 to about 2,000 g/t solids.

20. The method of claim 13 and further including: mixing the TiO₂-rich fraction with a binder, subsequently agglomerating and thermally treating the mixture at a temperature of at least about 800° C. and returning the mixture to the reactor.

21. The method of claim 20 wherein the binder is selected from the group consisting of: polymer solutions, surfactant solutions, salt solutions, and NaCl.

22. The method of claim 20 wherein the binder is about 10% to 30% by weight NaCl, referred to dry TiO₂.

23. The method of claim 13 and further including: mixing the TiO₂-rich fraction with a fine grained carrier material, subsequently agglomerating and thermally treating the mixture at a temperature of at least about 800° C. and returning the mixture to the reactor.

24. The method of claim 23 wherein the fine grained carrier material is selected from the group consisting of: TiO₂ Ti-containing slag and coke.
